(19) United States
(12) Patent Application Publication
(10) Pub. No.: US 2020/0393838 A1
(43) Pub. Date: Dec. 17, 2020

(54) METHOD AND SYSTEM FOR AUTOMATED DRIVER ASSISTANCE APPLIED TO INDUSTRIAL TRUCKS FOR ENHANCED DRIVER SAFETY AND COLLISION PREVENTION

(71) Applicant: Stocked Robotics, Inc., Austin, TX (US)

(72) Inventors: Saurav Agarwal, Austin, TX (US); Jacob Corder Currence, Austin, TX (US); Zoltan C. Bardos, Austin, TX (US); Aaron Riggs, Jonestown, TX (US)

(73) Assignee: Stocked Robotics, Inc., Austin, TX (US)

(21) Appl. No.: 16/899,095

(22) Filed: Jun. 11, 2020

Related U.S. Application Data
(60) Provisional application No. 62/859,999, filed on Jun. 11, 2019.

(51) Int. Cl. G05D 1/02; B60W 10/04; B60W 10/18; B60W 50/14; B60W 60/00; G05D 1/00

(52) U.S. Cl. CPC G05D 1/0214; B60W 10/04; B60W 10/18; B60W 50/14; B60W 60/001; G05D 1/0088; G05D 2201/0216; B60W 2520/12; B60W 2300/121; B60W 2720/10; B60W 2720/12; B60W 2710/18; B60W 2050/146; B60W 2520/10

(57) ABSTRACT

A system for automated driver assistance, comprising a plurality of sensors configured to generate sensor data, a vehicle controller configured to generate vehicle speed data, vehicle braking data, vehicle control commands and vehicle braking commands and a processor operating under algorithmic control and configured to receive the sensor data and the vehicle speed data, to process the sensor data and the vehicle speed data to generate control data, and to transmit the control data to the vehicle controller to cause the vehicle controller to generate the vehicle speed commands and the vehicle braking commands.

### RELATED APPLICATIONS

The present application claims priority to and benefit of U.S. provisional patent application 62/859,999, filed Jun. 11, 2019, and incorporates U.S. Ser. No. 16/183,592 filed Nov. 7, 2018, U.S. Ser. No. 16/198,579 filed Nov. 21, 2018, U.S. Ser. No. 16/255,399 filed Jan. 23, 2019, U.S. Ser. No. 16/597,723 filed Oct. 9, 2019 and U.S. Ser. No. 16/705,698 filed Dec. 6, 2019 by reference for all purposes, as if set forth herein in their entireties.

### TECHNICAL FIELD

The present disclosure relates generally to robotics, and more specifically to a method and system for automated driver assistance applied to industrial trucks for enhanced driver safety and collision prevention.

### BACKGROUND OF THE INVENTION

Robotic vehicle systems are known, but have numerous problems.

### SUMMARY OF THE INVENTION

A system for automated driver assistance, comprising a plurality of sensors configured to generate sensor data, a vehicle controller configured to generate vehicle speed data, vehicle braking data, vehicle control commands and vehicle braking commands and a processor operating under algorithmic control and configured to receive the sensor data and the vehicle speed data, to process the sensor data and the vehicle speed data to generate control data, and to transmit the control data to the vehicle controller to cause the vehicle controller to generate the vehicle speed commands and the vehicle braking commands.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 shows an example of a vehicle retrofitted with a driver assistance system, in accordance with an example embodiment of the present disclosure;

FIG. 2 shows an example of how a Safety Processing Unit (SPU), Safety Control Unit (SCU) and one proximity sensor can be mounted on an industrial truck e.g., Crown PR-4500, in accordance with an example embodiment of the present disclosure;

FIG. 3 is an example of how a proximity sensor such as a SICK Microscan3 can be mounted to an industrial truck like a CROWN PR-4500, in accordance with an example embodiment of the present disclosure;

FIG. 4 shows a visual depiction of a Safety Control Unit, in accordance with an example embodiment of the present disclosure;

FIG. 5 shows a visual depiction of an SPU, in accordance with an example embodiment of the present disclosure;

FIG. 6 shows an example of how signals flow from the sensor to the SPU and how the SPU receives driver override from the SCU, in accordance with an example embodiment of the present disclosure; and

FIG. 7 is a diagram of a flowchart algorithm of how various sub-systems of the driver assistance system work together, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The US Occupational Safety and Health Administration (OSHA) estimates that there are approximately 96,000 industrial truck accidents every year in the United States. These accidents may lead to death or serious bodily injury, aside from equipment and product damage in warehouses, distribution centers, manufacturing plants, and other such facilities.

The present disclosure is directed to a driver assistance system for automatic braking and collision prevention for industrial trucks. In addition to U.S. provisional patent application 62/859,999 filed Jun. 11, 2019, which the present application claims benefit of and priority to, the present application also incorporates U.S. Ser. No. 16/183,592 filed Nov. 7, 2018, U.S. Ser. No. 16/198,579 filed Nov. 21, 2018, U.S. Ser. No. 16/255,399 filed Jan. 23, 2019, U.S. Ser. No. 16/597,723 filed Oct. 9, 2019 and U.S. Ser. No. 16/705,698 filed Dec. 6, 2019 by reference for all purposes, as if set forth herein in their entireties. These related applications disclose additional details of safety systems for driver assistance.

The driver assistance system can be retrofitted to existing vehicles and is agnostic to the make or model of industrial truck that it is applied to. Further, this system is configured to capture data regarding driver behavior and vehicle maintenance and to wirelessly communicate with a remote computer system that can analyze the data and modify the behavior of the industrial truck in real-time. In particular, behavioral modification is accomplished by monitoring instances where emergency braking is applied by the vehicle control system instead of by the driver, and tracking the number of times that such situations occur. The driver is notified as they occur, and reports can also be generated for use by administrative personnel to identify drivers who need additional training.

The present disclosure provides an industrial truck to automatically sense obstacles in real-time using algorithmic structures operating on a truck controller processor as disclosed herein, and to automatically limit the speed of the vehicle, such as by applying braking mechanisms to prevent accidents, using algorithmic structures operating on a truck controller processor as disclosed herein that generate control commands for braking systems.

One or more sensing devices, such as a light-based safety curtain, laser scanner, camera or other suitable sensors that are configured to detect the presence of obstacles in the vicinity of an industrial truck, can be used. A computational processing device, referred to as Safety Processing Unit (SPU) that is able to receive proximity information from one or more sensors and calculate a control action to slow down a vehicle by modulating throttle signals or apply a braking mechanism to stop a vehicle, using algorithmic structures operating on a truck controller processor as disclosed herein. The SPU receives driver control inputs, modifies them as necessary and then communicates them to the vehicle's onboard control unit using algorithmic structures operating on a truck controller processor as disclosed herein.

Additionally, the SPU is configured to receive engine and preventative maintenance data (e.g., error codes) from the vehicle's onboard control system via a CAN bus or similar such interface, such as by using J1939 or other appropriate communication protocol, in combination with algorithmic structures operating on a truck controller processor as disclosed herein. Additionally, the SPU can be configured to communicate wirelessly, such as by using a WIFI or cellular communications system, to transmit data regarding driver behavior, proximity to obstacles, vehicle operation and maintenance and so forth to a remote computer server, using algorithmic structures operating on a truck controller processor as disclosed herein. The SPU is configured to wirelessly receive commands from a remote server to change its internal configuration including but not limited to speed limits, braking intensity and so forth, using algorithmic structures operating on a truck controller processor as disclosed herein.

The SPU can use control interfaces to allow it to receive human operator override commands through a Safety Control Unit (SCU) that can disable the braking system once the vehicle has been stopped due to a proximity alert, such that the driver is able to drive away at low speed. The stopping system becomes automatically active once the appropriate proximity zone is exited and infringed again, using algorithmic structures operating on a truck controller processor as disclosed herein.

A machine learning and artificial intelligence-enabled system that processes data streamed from various driver assistance devices and generates analytics and reports on safety, productivity, and maintenance that are made available by a web-based interface is also disclosed. This system is configured to categorize driver behavior based on pre-defined parameters and then to apply safety policies such as speed limits to prevent erratic behavior by a particular manual operator.

A geolocation tracking system is provided that uses Ultra High Frequency (UHF) signals to track the location of a vehicle in a facility, such that the SPU is able to apply location-based speed limits that can be configured remotely from a web-based management interface. The geolocation system comprises a UHF receiver (tag) that is installed to a vehicle and fixed broadcasting devices (anchors) that are strategically placed at various locations in a facility. A tag is able to calculate its position by triangulation by measuring its distance to 3 or more anchors, whose positions are known and can either be broadcast to the tag or stored in a memory device at the tag. The SPU is configured to read the position of the vehicle from the tag attached to a vehicle, such as by generating a query to the tag or by obtaining location data that is transmitted periodically to the SPU from the tag or in other suitable manners, and to apply the appropriate control actions, such as to throttle the speed control, to apply a brake control or to otherwise comply with the required safety rules.

Accidents related to industrial vehicles (such as from forklifts or tuggers) are a major cause of economic loss and can lead to a loss of life, and must be prevented, if possible. Such accidents can be prevented by the use of appropriate automated mechanisms. The present disclosure provides a driver assistance system that can be retrofitted to such vehicles.

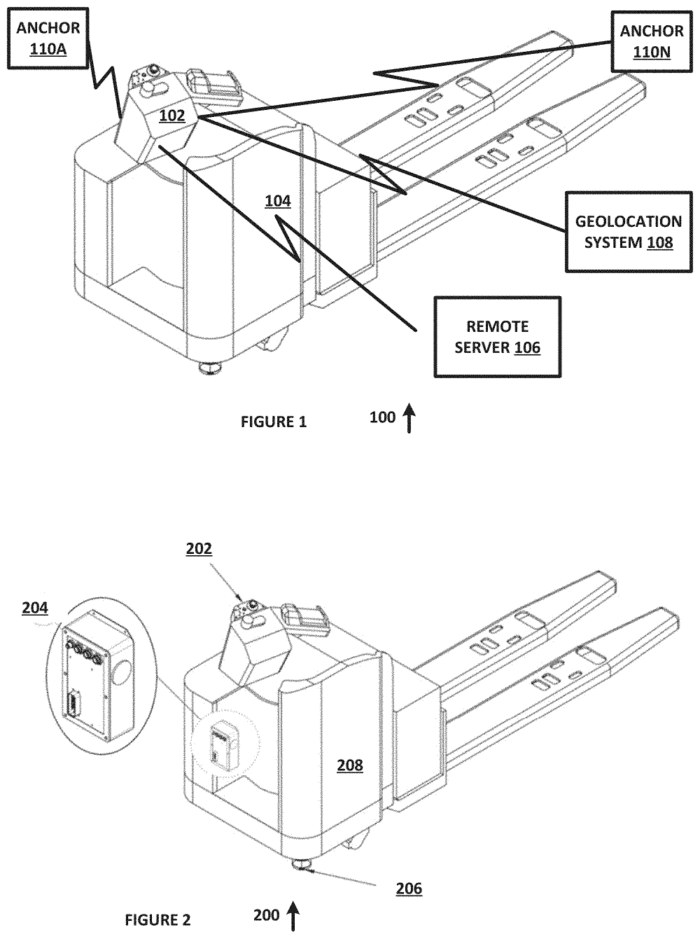

FIG. 1 is a diagram 100 of a vehicle 104 retrofitted with a driver assistance system 102, in accordance with an example embodiment of the present disclosure. The components of driver assistance system 102 can include one or more proximity sensors, an SPU, an SCU, and driver assistance system 102 can wirelessly interact with remote server 106, geolocation system 108, anchors 110A-N and other suitable systems and components, as discussed herein.

FIG. 2 is a diagram 200 of a vehicle 208 in accordance with an example embodiment of the present disclosure. Vehicle 208 includes driver control panel 202, SPU and SCU 204, and proximity sensor 206, each of which can be mounted on an industrial truck, such as a Crown PR-4500, in accordance with an example embodiment of the present disclosure.

Proximity sensor 206 can include one or more camera, LIDAR unit, safety scanner or other suitable devices that can be used to sense the presence of obstacles in the vicinity of a vehicle. The field of view of the proximity sensor can divided into three proximity zones, or other suitable numbers of zone. In this example embodiment, a Warning Zone 1 can be the first zone that is used to generate an alert as a vehicle approaches an object. Once an object enters this zone, the driver assistance system can automatically apply a gentle brake by pulsing the brake (rapid on/off control) and limit the top speed of the vehicle. The number and duration of brake pulse can be configured in one or more algorithms that are operating onboard one of the microprocessors onboard the SPU. Activation of this braking signal by the operator can suppress activation of this signal by SPU and SCU 204, and can be stored in a database and used to rate the operator. Likewise, if the operator fails to detect the need for activation of this braking signal, a first score can be assigned against the operator for the event, and the details of the event can be stored in the database and used to rate the operator (e.g vehicle location, vehicle speed, image data of the object and so forth).

A Warning Zone 2 can be the second zone that is used to generate an alert if an object transitions from Warning Zone 1, such as by moving closer to the vehicle or by the vehicle moving closer to the object. Once an object enters Warning Zone 2, the driver assistance system can apply multiple brake pulses to slow down the vehicle further and to limit the vehicle speed further. Activation of this braking signal by the operator can suppress activation of this signal by SPU and SCU 204, and can be stored in a database and used to rate the operator. Likewise, if the operator fails to detect the need for activation of this braking signal, a second score can be assigned against the operator for the event, and the details of the event can be stored in the database and used to rate the operator (e.g vehicle location, vehicle speed, image data of the object and so forth).

A third or Stop Zone can be used to detect that an object has entered the Stop Zone, and to cause the driver assistance system to apply brakes to stop the vehicle. Activation of this braking signal by the operator can suppress activation of this signal by SPU and SCU 204, and can be stored in a database and used to rate the operator. Likewise, if the operator fails to detect the need for activation of this braking signal, a third score can be assigned against the operator for the event, and the details of the event can be stored in the database and used to rate the operator (e.g vehicle location, vehicle speed, image data of the object and so forth).

The first score, second score and third score data can be tabulated in real time and used to identify operators who require immediate assistance, such as when a number of first scores, second scores and third scores exceed one or more predetermined settings. For example, any time an operator concurrently generates a first score, a second score and a third score, indicating that the operator failed to generate any required braking signals associated with a complete stopping of the vehicle, a supervisor can be notified, the vehicle can be disabled or other suitable procedures can be implemented, to ensure operator and vehicle safety. The first scores, second scores and third scores can also be tabulated over time and used to determine if an operator requires training. The first scores, second scores and third scores can also or alternatively be modified, such as where an operator actuates the brake within a predetermined time period after the system actuates the brake. In this example embodiment, the operator might activate the brake within the standard human reaction time for responding to an event, which can range from several hundred milliseconds to several seconds, depending on conditions. If the operator activates the brake within such times, the scores can be modified, or the activation time data can otherwise be used for operator review and training purposes.

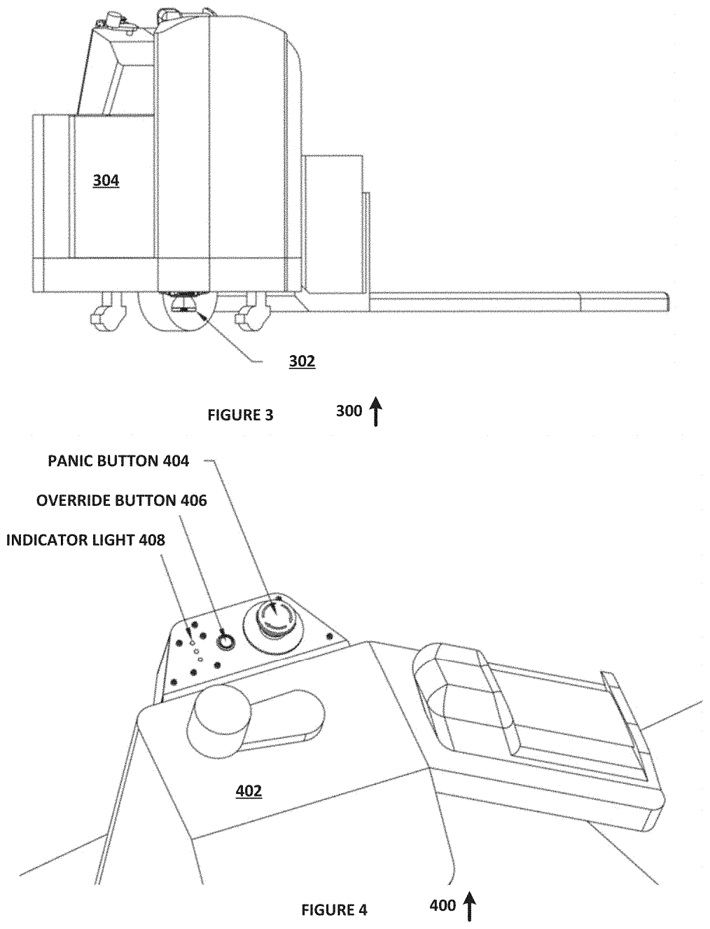

FIG. 3 is a diagram 300 of a vehicle 304 with a proximity sensor 302, in accordance with an example embodiment of the present disclosure. Proximity sensor 302 can be a SICK Microscan3 can be mounted to an industrial truck like a CROWN PR-4500, or other suitable devices or systems.

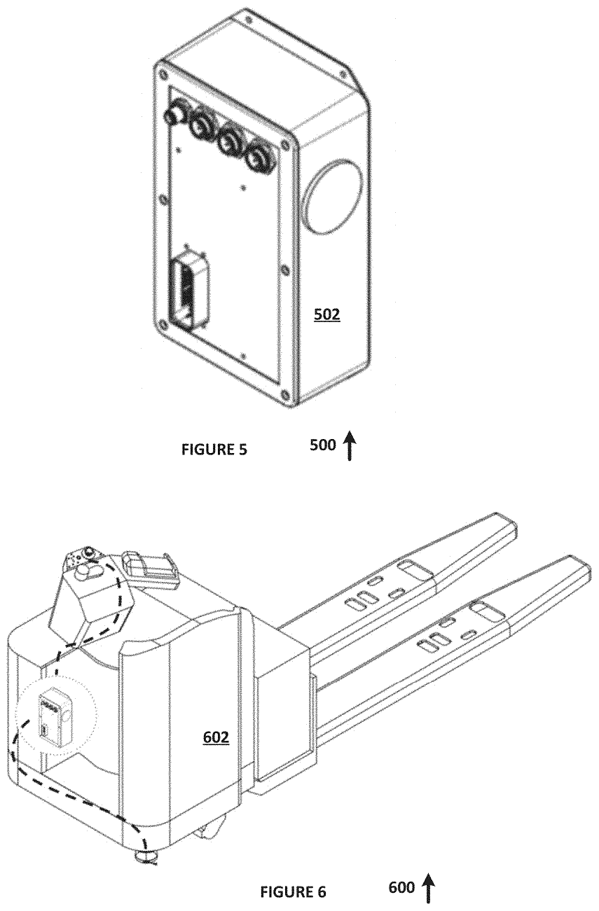

FIG. 4 is a diagram 400 of an SCU 402, in accordance with an example embodiment of the present disclosure. Remote Server. SCU 402 can include panic button 404, override button 406 and indicator light 408, as well as other suitable systems and components.

In one example embodiment, a remote server can communicate with an SPU via an Internet connection, wirelessly or in other suitable manners, and can be configured to provide 1) a web-based interface which a supervisor can log in to, using a computer device equipped with an Internet connection and a web browser; 2) a computational back-end processor that operates under algorithmic control to process data received from a driver assistance system and to display analytics and reports using Machine Learning and Artificial Intelligence enabled algorithms; 3) software updates to the driver assistance system remotely by transferring a file of executable code via a wireless or Internet connection; 4) commands to a driver assistance system to change or modify vehicle behavior, such as to impose speed limits, to apply a brake strength, and for other suitable purposes.

The geolocation system can be used to track the position of a vehicle in real-time within a facility with high-precision, such as by using anchors, which are broadcast devices that transmit a smart signal using Ultra High-Frequency radio band, tags, which are receiver devices that receive signals from multiple anchors and triangulate their position based on range measurements to 3 or more anchors, or in other suitable manners. Using data that defines a vehicle's position in a facility, location-based speed limits and automated modifications can be made to vehicle behavior to enhance safety.

FIG. 5 is a diagram 500 of an SPU 502, in accordance with an example embodiment of the present disclosure. SPU 502 can include electronics that are configured to draw power from the vehicle battery or another onboard power source such that it does not require the installation a secondary source of power. SPU 502 can further include 1) data connectors that are configured to receive data from the vehicle's control unit and the proximity sensor or sensors; 2) data connectors that transmit data to an SCU; 3) data connectors that transmit data to the vehicle's control system; 4) microprocessors that are configured by one or more software-implemented algorithms that are stored in a memory device to process the proximity sensor data and to apply vehicle controls as described (such as throttle and braking controls) to modify the vehicle behavior; 5) a wireless communication device that allows SPU 502 to exchange data via cellular or WI-FI signals to a remote server over the Internet; 6) a buzzer or another audio output device that creates audio alerts based on different internal states as defined in algorithms that run on the microprocessors in SPU 502 and other suitable functions.

SPU 502 controls the behavior of the vehicle by utilizing one or more algorithms operating on a processor of SPU 502 to apply the appropriate throttle and brake commands by algorithmic processing of proximity sensor data, SCU inputs for override and panic button controls and other suitable data.

FIG. 6 is a diagram 600 of data signal flows from a sensor to the SPU and how the SPU receives driver override from an SCU, in accordance with an example embodiment of the present disclosure.

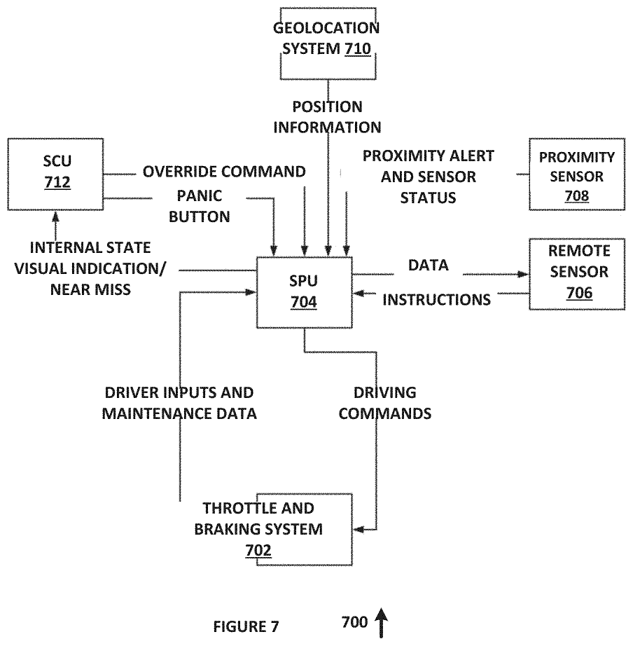

FIG. 7 is a state diagram of an algorithm 700 for controlling interoperation of subsystems of a driver assistance system, in accordance with an example embodiment of the present disclosure. Algorithm 700 can be implemented in hardware or a suitable combination of hardware and software.

Algorithm 700 includes data and controls that are transmitted from vehicle 702 to SPU 704. In one example embodiment, the data and controls can include driving commands that are received from SPU 704 and driver inputs and maintenance data that is transmitted from vehicle 702 to SPU 704, or other suitable data as discussed and described herein. The data and controls can be generated periodically, can be generated when a state change occurs, or can be generated in other suitable manners.

Algorithm 700 includes data that is transmitted from remote sensor 706 to SPU 704 and controls (instructions) that are transmitted from SPU 704 to remote sensor 706. The data and controls can be generated periodically, can be generated when a state change occurs, or can be generated in other suitable manners.

Algorithm 700 includes proximity alert and sensor status data that is transmitted from proximity sensor 708 to SPU 704. The data can be generated periodically, can be generated when a state change occurs, or can be generated in other suitable manners.

Algorithm 700 includes position data that is transmitted from geolocation system 710 to SPU 704. The data can be generated periodically, can be generated when a state change occurs, or can be generated in other suitable manners.

Algorithm 700 includes data and controls that are transmitted from SCU 712 to SPU 704. In one example embodiment, the data and controls can include internal state, visual indication, near miss and other suitable data and commands that are received from SPU 704 and override command and panic button data that is transmitted from SCU 712 to SPU 704, or other suitable data as discussed and described herein. The data and controls can be generated periodically, can be generated when a state change occurs, or can be generated in other suitable manners.

Although algorithm 700 is shown as a state diagram, one or skill in the art will recognize that it can also or alternatively be implemented as a flow chart, a ladder diagram or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for automated driver assistance, comprising:
a plurality of sensors configured to generate sensor data;
a vehicle controller configured to generate vehicle speed data, vehicle braking data, vehicle control commands and vehicle braking commands; and
a processor operating under algorithmic control and configured to receive the sensor data and the vehicle speed data, to process the sensor data and the vehicle speed data to generate control data, and to transmit the control data to the vehicle controller to cause the vehicle controller to generate the vehicle speed commands and the vehicle braking commands.

2. The system of claim 1 wherein the processor is configured to generate a plurality of proximity zones and to determine whether the vehicle has entered one or more of the proximity zones.

3. The system of claim 1 wherein the processor is configured to generate a first proximity zone and a second proximity zone, to determine whether the vehicle has entered the first proximity zone or the second proximity zone, and to generate control data that causes the vehicle controller to generate a first brake signal if the vehicle has entered the first proximity zone and a second brake signal if the vehicle has entered a second proximity zone.

4. The system of claim 3 wherein the processor is configured to generate a first score if the first brake signal is generated and a second score if the second brake signal is generated.

5. The system of claim 4 wherein the processor is configured to determine whether the vehicle braking data has been received within a predetermined period of a time when the first brake signal is generated.

6. The system of claim 4 wherein the processor is configured to determine whether the vehicle braking data has been received within a predetermined period of a time when the first brake signal is generated and to modify the first score if the vehicle braking data has been received within a predetermined period of a time when the first brake signal is generated.

7. The system of claim 4 wherein the processor is configured to determine whether first vehicle braking data has been received within a first predetermined period of a time when the first brake signal is generated and whether second vehicle braking data has been received within a second predetermined period of a time when the second brake signal is generated.

8. The system of claim 7 wherein the processor is configured to modify the first score if the vehicle braking data has been received within the first predetermined period of a time when the first brake signal is generated and to modify the second score if the vehicle braking data has been received within the second predetermined period of a time when the second brake signal is generated.

9. The system of claim 1 wherein the processor is configured to generate a plurality of scores for a plurality of operators in response to one or more braking criteria and to generate a user interface that displays the plurality of scores for the plurality of operators.

10. A method for automated driver assistance, comprising:
generating sensor data with a plurality of sensors;
generating vehicle speed data, vehicle braking data, vehicle control commands and vehicle braking commands with a vehicle controller; and
receiving the sensor data and the vehicle speed data at a processor operating under algorithmic control; and
processing the sensor data and the vehicle speed data with the processor to generate control data; and
transmitting the control data from the processor to the vehicle controller to cause the vehicle controller to generate the vehicle speed commands and the vehicle braking commands.

11. The method of claim 10 further comprising:
generating a plurality of proximity zones using the processor; and
determining whether the vehicle has entered one or more of the proximity zones using the processor.

12. The method of claim 10 further comprising:
generating a first proximity zone and a second proximity zone using the processor;
determining whether the vehicle has entered the first proximity zone or the second proximity zone using the processor; and
generating control data using the processor that causes the vehicle controller to generate a first brake signal if the vehicle has entered the first proximity zone and a second brake signal if the vehicle has entered a second proximity zone.

13. The method of claim 12 further comprising generating a first score using the processor if the first brake signal is generated and a second score if the second brake signal is generated.

14. The method of claim 13 further comprising determining with the processor whether the vehicle braking data has been received within a predetermined period of a time when the first brake signal is generated.

15. The method of claim 13 further comprising:
determining with the processor whether the vehicle braking data has been received within a predetermined period of a time when the first brake signal is generated; and
modifying the first score with the processor if the vehicle braking data has been received within a predetermined period of a time when the first brake signal is generated.

16. The method of claim 13 further comprising determining with the processor whether first vehicle braking data has been received within a first predetermined period of a time when the first brake signal is generated and whether second vehicle braking data has been received within a second predetermined period of a time when the second brake signal is generated.

17. The method of claim 16 further comprising:
modifying the first score with the processor if the vehicle braking data has been received within the first predetermined period of a time when the first brake signal is generated; and
modifying the second score with the processor if the vehicle braking data has been received within the second predetermined period of a time when the second brake signal is generated.

18. The method of claim 10 further comprising:
generating a plurality of scores for a plurality of operators using the processor in response to one or more braking criteria; and
generating a user interface using the processor that displays the plurality of scores for the plurality of operators.
